(19) United States
(12) Patent Application Publication
(10) Pub. No.: US 2020/0100204 A1
(43) Pub. Date: Mar. 26, 2020

(54) LOCATION TRACKER

(71) Applicant: Honeywell International Inc., Morris Plains, NJ (US)

(72) Inventors: Hai D. Pham, Eden Prairie, MN (US); Kevin Graebel, Plymouth, MN (US); Robert C. Becker, Golden Valley, MN (US); Adam P. Boutz, Golden Valley, MN (US)

(21) Appl. No.: 16/138,563

(22) Filed: Sep. 21, 2018

(51) Int. Cl. H04W 64/00; G01S 5/00; G01S 11/08; G01S 11/06

(52) U.S. Cl. CPC H04W 64/003; G01S 11/06; G01S 11/08; G01S 5/0036

(57) ABSTRACT

Devices, methods, systems, and computer-readable media for calculating a distance and direction from a location tracker to a location of a node are described herein. One or more embodiments include a transmit element to transmit a search command for a first node to one or more nodes, a receive element to receive wireless transmissions from the one or more nodes including range data between the location tracker and each of the one or more nodes, and a time of flight (ToF) ranging calculator to convert the range data to a distance measurement from the location tracker to the first node.

### TECHNICAL FIELD

The present disclosure relates to methods, devices, systems, and computer-readable media for calculating a distance and direction from a location tracker to a location of a node.

### BACKGROUND

Location trackers can be utilized in many fields. High risk workers who are in large buildings, warehouses, oil and gas refineries, first responders, firefighters, police, and members of the military can use location trackers frequently. For example, location trackers can determine the distance and direction from a location of a firefighter in a burning building to an exit. If the firefighter needs to exit the burning building, the firefighter can be guided to the exit even with poor visibility using a location tracker.

Location trackers can also be used to find hidden objects. For example, location trackers can be used to find utility meters, sensors in a factory, mine, or refinery, a landmine in a war zone, a drone, or a shipping package.

Tracking and guiding can be done using a global positioning system (GPS). However, in some environments, GPS is unavailable. These environments can be called GPS denied environments. Tracking and guiding in a GPS denied environment can be extremely difficult. Often users of location trackers, like first responders or military personnel in war zones, are entering areas where GPS is unavailable. For example, GPS can be unavailable in some buildings.

In some environments, GPS can be unreliable. For example, GPS can be unreliable due to inadequate accuracy. Inadequate accuracy can prevent pinpointing an object's location and reduce the likelihood of finding an object.

Current location tracking and guiding devices that do not require the use of GPS can be expensive and can require a lengthy installation and calibration process prior to use. A lengthy installation and calibration process can result in a delay to searching for victims, for example. In some circumstances, a delay can lead to more severe injuries, a loss of life, or loss of profits.

### BRIEF DESCRIPTION OF THE DRAWINGS

FIG. 1 is a diagram of an example location tracker that can be utilized according to an embodiment of the present disclosure.

FIG. 2 is a diagram of an example of a system for a location tracker that can be utilized according to an embodiment of the present disclosure.

### DETAILED DESCRIPTION

The present disclosure relates to methods, devices, systems, and computer-readable media for calculating a distance and direction from a location tracker to a location of a node.

A distance and direction of a location tracker to a node can be calculated according to embodiments of the present disclosure. For example, in some embodiments, the distance and direction of a location tracker to a node can be calculated using a location tracker. In various embodiments, the location tracker can be coupled to a person, a robot, or a vehicle.

The location tracker can be, but is not limited to, a radio, a mobile device, or a wearable device. The wearable device can be a smart watch, smart goggle, smart safety vest, smart safety shoes, smart headphone, or smart fall protection safety harness device, for example.

The location tracker can include a transmit element, a receive element, and a time of flight (ToF) ranging calculator. The transmit element can transmit commands from the location tracker to one or more nodes. For example, the transmit element can transmit a search command for a node to one or more nodes.

In some embodiments, the commands can be wireless transmissions. The wireless transmissions can be transmitted via long range (LoRa) modulated, LoRaWAN, Wi-Fi, 15.4 mesh, Bluetooth, Bluetooth mesh, or a combination thereof. For example, the wireless transmissions can be transmitted using a 2.4 GHz industrial, scientific, and medical radio band (ISM band) LoRa modulation, which is a combination of LoRa, Wi-Fi, 15.4, and Bluetooth mesh.

The receive element can allow the location tracker to receive the wireless transmissions from the one or more nodes. The wireless transmissions can include range data between the location tracker and each of the one or more nodes.

For example, a node can receive a search command for the node from the location tracker. In response to receiving the command, the node can send a wireless transmission including range data to the location tracker.

The ToF ranging calculator can convert the range data to a distance measurement. The distance measurement can be from the location tracker to the first node. The range data can be converted by the ToF ranging calculator using a processor.

The wireless transmissions can include relative received signal strength (RSSI) data. The location tracker can include a high gain antenna to receive the RSSI data and a RSSI calculator to analyze the RSSI data. The RSSI calculator can be used to determine a direction from the location tracker to the first node.

In some examples, the location tracker can include a speaker, a light source, and/or a user interface. The speaker, light source, user interface, or a combination thereof can be used to convey to a user the distance and/or the direction from the location tracker to the first node.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

The figures herein follow a numbering convention in which the first digit corresponds to the drawing figure number and the remaining digits identify an element or component in the drawing. Similar elements or components between different figures may be identified by the use of similar remaining digits.

As used herein, “a” or “a number of” something can refer to one or more such things. For example, “a number of devices” can refer to one or more devices.

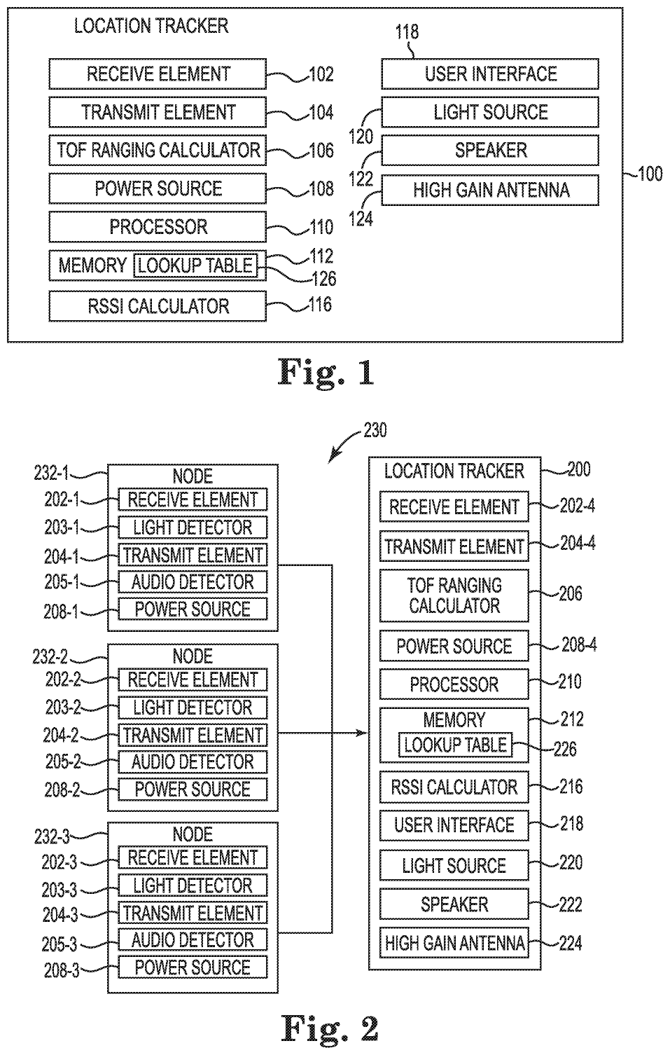

FIG. 1 is a diagram of an example location tracker that can be utilized according to an embodiment of the present disclosure. In some examples, a location tracker 100 can include a receive element 102, a transmit element 104, a time of flight (ToF) ranging calculator 106, a power source 108, a processor 110, a memory 112, a relative received signal strength (RSSI) calculator 116, a user interface 118, a light source 120, a speaker 122, and a high gain antenna 124.

A location tracker 100 can be used to calculate a distance and direction from the location tracker 100 to a node of one or more nodes (e.g., node 232-1, 232-2, 232-3 in FIG. 2). In some examples, the location tracker 100 can also guide the user to the node using a user interface 118, a light source 120, and/or a speaker 122.

In some embodiments, the location tracker 100 can be coupled to a person, a robot, or a vehicle. As discussed above, the location tracker 100 can be, but is not limited to, a radio, a mobile device, or a wearable device. The wearable device can be a smart watch, smart goggle, smart safety vest, smart safety shoes, smart headphone, or smart fall protection safety harness device, for example.

The transmit element 104 can transmit a command to one or more nodes (e.g., nodes 232-1, 232-2, 232-3 in FIG. 2) to request range data. The command can be a search command for a first node (e.g., first node 232-1 in FIG. 2), for example.

The search command can include an address of the first node (e.g., first node 232-1 in FIG. 2). The address can be used by the one or more nodes (e.g., nodes 232-1, 232-2, 232-3 in FIG. 2) to identify the first node. The address of the first node can be stored in a lookup table 126 in a memory 112 of the location tracker 100. The lookup table 126 can include one or more addresses corresponding to the one or more nodes (e.g., nodes 232-1, 232-2, 232-3 in FIG. 2).

The transmit element 104 can include a transmitter and an antenna, for example. The wireless transmissions can be transmitted via any number of methods, such as, but not limited to, LoRa modulated, LoRaWAN, WiFi, 15.4 mesh, Bluetooth, or Bluetooth mesh. For example, the wireless transmissions can be transmitted using a 2.4 GHz ISM band LoRa modulation, which is a combination of LoRa, Wi-Fi, 15.4, and Bluetooth mesh. In some examples, the location tracker 100 can transmit the search command via LoRa modulation in response to GPS being unavailable.

The receive element 102 of the location tracker 100 can allow the location tracker 100 to receive wireless transmissions from the one or more nodes (e.g., nodes 232-1, 232-2, 232-3 in FIG. 2). The receive element 102 can be an antenna.

The wireless transmissions can include range data between the location tracker 100 and each of the one or more nodes (e.g., nodes 232-1, 232-2, 322-3 in FIG. 2). For example, the range data can be range data from the first node (e.g., first node 232-1 in FIG. 2) sent in response to the first node receiving a search command for the first node from the location tracker 100. In some examples, the one or more nodes can transmit the range data via LoRa modulation in response to GPS being unavailable.

The range data can also be ToF LoRa ranging data. The ToF LoRa ranging data of the wireless transmissions from the one or more nodes (e.g., nodes 232-1, 232-2, 232-3 in FIG. 2) can include relative received signal strength (RSSI) data.

The location tracker 100 can include a high gain antenna 124 to receive the RSSI data. High gain antennas can have a narrow radio wave beam width to enable precise targeting of radio signals including the wireless transmissions from the one or more nodes (e.g., nodes 232-1, 232-2, 232-3 in FIG. 2). In some examples, the high gain antenna 124 can be a directional antenna. For example, the directional antenna can be a yagi antenna. The high gain antenna 124 can measure the RSSI of the wireless transmissions.

The RSSI data can be analyzed by a RSSI calculator 116. The RSSI calculator 116 can be included in the location tracker 100. The RSSI calculator 116 can analyze the RSSI data to determine a direction from the location tracker 100 to the first node (e.g., first node 232-1 in FIG. 2). For example, the RSSI calculator 116 can determine the direction from the location tracker 100 to the first node based on the direction with the highest RSSI.

The ToF ranging calculator 106 and a processor 110 can convert the range data to a measurement of the distance from the location tracker 100 to a node of the one or more nodes (e.g., nodes 232-1, 232-2, 232-3 in FIG. 2). For example, the first node (e.g., node 232-1 in FIG. 2) can send range data in response to the first node receiving the search command from the location tracker 100.

In some examples, the ToF ranging calculator 106 can convert the range data to a radial distance. That is, the distance measurement can be the shortest distance between the location tracker 100 and the first node (e.g., first node 232-1 in FIG. 2). The distance measurement can be in a Cartesian coordinate system in absolute x-coordinates and y-coordinates, with units of feet, miles, yards, meters, or kilometers, for example, or a position-relative measurement.

As discussed above, the location tracker 100 can include a memory 112. The memory 112 can store the range data and the distance measurements. The memory 112 can also store addresses of the one or more nodes (e.g., nodes 232-1, 232-2, 232-3 in FIG. 2).

In some examples, the location tracker 100 can include a power source 108. In some examples, the power source 108 can be from power harvesting, a battery, a fuel cell, or a supercapacitor.

The location tracker 100 can include a user interface 118. The distance and/or direction of the location tracker 100 to a node of the one or more nodes (e.g., nodes 232-1, 232-2, 232-3 in FIG. 2) can be displayed by the location tracker 100 to a user via the user interface 118.

For example, the user interface 118 can include a display to convey the distance and/or direction to the user. In some examples, the user interface 119 can display a map including a location of the location tracker 100 and a location of one or more nodes (e.g., nodes 232-1, 232-2, 232-3 in FIG. 2). The user interface 118 can be, but is not limited to, a mobile device, such as a smart phone, tablet, or computer with an ethernet connection.

A light source 120 can be included in the location tracker 100. The light source 120 can emit light in different colors, shades, shapes, patterns and/or can emit light in varying frequency. In some examples, the light source 120 can emit a light or a number of lights based on the distance and/or direction from the location tracker 100 to a node of the one or more nodes (e.g., nodes 232-1, 232-2, 232-3 in FIG. 2).

In a number of embodiments, the light source 120 can emit a particular color or shade of light based on the distance of the location tracker 100 from a node of the one or more nodes (e.g., nodes 232-1, 232-2, 232-3 in FIG. 2). For example, the light source 120 can emit a red light in response to the location tracker 100 being approximately fifteen to twenty feet from a node and an orange light in response to the location tracker 100 being approximately ten to fourteen feet from a node.

The light source 120 can pulsate the emitted light. For example, the light source 120 can turn a light on and off with more or less frequency depending on whether the location tracker 100 is pointing and/or the user of the location tracker 100 is facing approximately towards the direction of the node of the one or more nodes (e.g., nodes 232-1, 232-2, 232-3 in FIG. 2) or away from the direction of the node.

In some examples, the light source 120 can pulsate the emitted light at a high frequency in response to the location tracker 100 pointing towards the direction of a first node (e.g., node 232-1 in FIG. 2) within approximately five degrees. The light source 120 can pulsate the emitted light at a medium frequency within approximately ten degrees of the direction of the first node and pulsate at a low frequency within approximately twenty degrees of the direction of the first node.

The location tracker 100 can include a speaker 122. The speaker 122 can provide an audio tone or a number of audio tones. In some examples, the speaker can provide an audio tone based on the distance and/or direction of the location tracker 100 to a node of the one or more nodes (e.g., nodes 232-1, 232-2, 232-3 in FIG. 2).

For example, the speaker 122 can pulsate the audio tone by turning the tone on and off with more or less frequency in response to the location tracker 100 getting closer or farther from the a first node (e.g., node 232-1 in FIG. 2).

In some examples, the speaker 122 can adjust the volume of the audio tone in response to the location tracker 100 pointing towards or away from the node (e.g., node 232-1 in FIG. 2). For example, the volume of the audio tone can be higher in response to the location tracker pointing towards the direction of the first node within approximately five degrees and the volume can be lower in response to the location tracker pointing towards the direction of the first node within approximately ten degrees.

FIG. 2 is a diagram of an example of a system for a location tracker that can be utilized according to an embodiment of the present disclosure. The system 230 can include a location tracker 200 and one or more nodes 232-1, 232-2, 232-3.

Each of the one or more nodes 232-1, 232-2, 232-3 can include a receive element 202-1, 202-2, 202-3, a transmit element 204-1, 204-2, 204-3, a power source 208-1, 208-2, 208-3, a light detector 203-1, 203-2, 203-3, and an audio detector 205-1, 205-2, 205-3.

The one or more nodes 232-1, 232-2, 232-3 can transmit range data via the transmit element 204-1, 204-2, 204-3. The one or more nodes 232-1, 232-2, 232-3 can transmit range data in response to receiving a command from the location tracker 200. The one or more nodes 232-1, 232-2, 232-3 can receive the command from the location tracker 200 via the receive element 202-1, 202-2, 202-3.

In some examples, the one or more nodes 232-1, 232-2, 232-3 receive a search command from the location tracker 200. The search command includes an address of a first node 232-1 of the one or more nodes 232-1, 232-2, 232-3. In response, the first node 232-1 recognizes the address as its address and sends a wireless transmission to the location tracker 200. In some examples, the wireless transmission can include range data and RSSI data to be analyzed by the location tracker 200 to assist the location tracker 200 and/or user to locate the first node 232-1.

The one or more nodes 232-1, 232-2, 232-3 can be scattered over an area. The distance between the one or more nodes 232-1, 232-2, 232-3 and the location tracker 200 can depend on the environment and the transmitted power. For example, the distance between the one or more nodes 232-1, 232-2, 232-3 and the location tracker 200 in a square acre of an open field can be greater than the distance between the one or more nodes 232-1, 232-2, 232-3 and the location tracker 200 in a square acre of a warehouse, a multipath environment. Barriers between a transmit element 204-1, 204-2, 204-3 and receive element 202-4 can weaken a transmission signal. As such, a transmit element 204-1, 204-2, 204-3 may use more power from a power source 208-1, 208-2, 208-3 to strengthen the transmission signal.

The one or more nodes 232-1, 232-2, 232-3 can include a plurality of transmitter power levels. The amount of power in the one or more transmit elements 204-1, 204-2, 204-3 can dictate the distance that can be between the one or more nodes 232-1, 232-2, 232-3 and the location tracker 200.

For example, the further the distance the transmissions must travel, the more power that a node of the one or more nodes 232-1, 232-2, 232-3 needs to transmit. The closer the distance the transmission must travel, the less power that a node of the one or more nodes 232-1, 232-2, 232-3 needs to transmit.

The one or more nodes 232-1, 232-2, 232-3 can use an adaptive transmit power technique. The adaptive transmit power technique can allow the one or more nodes 232-1, 232-2, 232-3 to save power by tuning the transmit power of the transmit element based on the distance the transmission must travel.

The one or more nodes 232-1, 232-2, 232-3 can each include a light detector 203-1, 203-2, 203-3. The light detectors 203-1, 203-2, 203-3 can receive light emitted from the light source 220. The light can be infrared light, for example.

In some examples, the first light detector 203-1 of the first node 232-1 can receive one or more lights. The first node 232-1 can be programmed to respond to a first light of the one or more lights. In some examples, the first node 232-1 can turn on, exit low power mode, exit energy saver mode, exit sleep mode, or provide a signal to the location tracker 200 and/or the user, in response to receiving the first infrared light.

The one or more nodes 232-1, 232-2, 232-3 can each include an audio detector 205-1, 205-2, 205-3. The audio detectors 205-1, 205-2, 205-3 can receive audio tones from the speaker 222 of the location tracker 200.

In some examples, the first audio detector 205-1 of the first node 232-1 can receive one or more audio tones. The first node 232-1 can be programmed to respond to a first audio tone of the one or more audio tones. In some examples, the first node 232-1 can turn on, exit low power mode, exit energy saver mode, exit sleep mode, or provide a signal to the location tracker 200 and/or the user, in response to receiving the first audio tone.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A location tracker, comprising:
a transmit element to transmit a search command for a first node to one or more nodes;
a receive element to receive wireless transmissions from the one or more nodes including range data between the location tracker and each of the one or more nodes;
a time of flight (ToF) ranging calculator to convert the range data to a distance measurement from the location tracker to the first node; and
a speaker to provide a particular audio tone based on the distance measurement from the location tracker to the first node.

2. The location tracker of claim 1, wherein the wireless transmissions are via at least one of: long range (LoRa) modulated, LoRaWAN, WiFi, 15.4 mesh, Bluetooth, or Bluetooth mesh.

3. The location tracker of claim 1, wherein the search command includes an address of the first node from a lookup table.

4. The location tracker of claim 1, wherein the wireless transmissions include relative received signal strength (RSSI) data.

5. The location tracker of claim 4, further including a high gain antenna to receive the RSSI data.

6. The location tracker of claim 5, further including a RSSI calculator to analyze the RSSI data to determine a direction from the location tracker to the first node.

7. The location tracker of claim 6, wherein the speaker provides a different audio tone based on the direction from the location tracker to the first node.

8. The location tracker of claim 6, further including a light source to emit a light based on at least one of: the distance measurement or the direction from the location tracker to the first node.

9. The location tracker of claim 6, further including a user interface to display at least one of: the distance measurement or the direction from the location tracker to the first node.

10. A system for a location tracker, comprising:
one or more nodes to transmit range data; and
a location tracker configured to:
transmit a search command for a first node to the one or more nodes;
receive the range data from the one or more nodes;
convert the range data to a distance measurement from the location tracker to the first node; and
provide a particular audio tone based on the distance measurement from the location tracker to the first node.

11. The system of claim 10, wherein the location tracker transmits the search command via long range (LoRa) modulation in response to a global positioning system (GPS) being unavailable.

12. The system of claim 10, wherein the one or more nodes transmit range data via long range (LoRa) modulation in response to a global positioning system (GPS) being unavailable.

13. The system of claim 10, wherein the one or more nodes each include a light detector.

14. The system of claim 10, wherein the one or more nodes each include an audio detector.

15. The system of claim 10, wherein the range data is time of flight (ToF) long range (LoRa) data.

16. A system for a location tracker, comprising:
one or more nodes to transmit a wireless transmission including range data and relative received signal strength (RSSI) data; and
a location tracker, comprising:
a transmit element to transmit a search command for a first node to the one or more nodes;
a receive element to receive the range data from the one or more nodes;
a time of flight (ToF) ranging calculator configured to convert the range data to a distance measurement from the location tracker to the first node;
a high gain antenna to receive the relative received signal strength (RSSI) data;
a relative received signal strength (RSSI) ranging calculator to analyze the relative received signal strength (RSSI) data to determine the direction from the location tracker to the first node; and
a speaker to provide a particular audio tone based on the distance measurement from the location tracker to the first node.

17. The system of claim 16, wherein the high gain antenna is a yagi antenna.

18. The system of claim 16, wherein a light source emits a particular color or shade of light based on at least one of: the distance or the direction from the location tracker to the first node.

19. The system of claim 16, wherein the speaker provides a different audio tone volume based on the direction from the location tracker to the first node.

20. The system of claim 16, wherein the user interface displays a map including a location of the location tracker and a location of the first node.
